(19) United States
(12) Patent Application Publication
(10) Pub. No.: US 2026/0260406 A1
(43) Pub. Date: Sep. 3, 2026

(54) STYLIZED IMAGE REPRESENTATIONS

(71) Applicant: Apple Inc., Cupertino, CA (US)

(72) Inventor: Thomas J. MOORE, Northglenn, CO (US)

(21) Appl. No.: 19/552,737

(22) Filed: Feb. 27, 2026

Related U.S. Application Data
(60) Provisional application No. 63/765,443, filed on Feb. 28, 2025.

(51) Int. Cl. G06T 11/60; G06T 7/00; G06V 10/764

(52) U.S. Cl. CPC G06T 11/60; G06T 7/0002; G06T 2200/24; G06T 2207/20081; G06T 2207/20084; G06T 2207/30168; G06V 10/764

(57) ABSTRACT

Disclosed herein are example processes for generating stylized images including objects. An example process includes obtaining an input image, automatically generating a modified image including a stylized version of an object in the input image when the input image satisfies a first set of criteria, and saving the input image when the input image does not satisfy the first set of criteria.

### CROSS-REFERENCE TO RELATED APPLICATIONS

This application claims priority to U.S. Provisional Patent Application No. 63/765,443, entitled “STYLIZED IMAGE REPRESENTATIONS” filed on February 28, 2025, the contents of which is hereby incorporated by reference in its entirety.

### TECHNICAL FIELD

The present disclosure generally relates to generating representations of objects detected in images.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more image sensors: obtaining, using the one or more image sensors, an input image including an object; and in response to obtaining the input image including the object: in accordance with a determination that the input image satisfies a first set of criteria, automatically generating a modified image including a stylized version of the object; and in accordance with a determination that the input image does not satisfy the first set of criteria, saving the input image without generating the modified image.

Example non-transitory computer-readable storage media are disclosed herein. An example non-transitory computer-readable storage medium stores one or more programs. The one or more programs are configured to be executed by one or more processors of a computer system that is in communication with one or more image sensors. The one or more programs include instructions for: obtaining, using the one or more image sensors, an input image including an object; and in response to obtaining the input image including the object: in accordance with a determination that the input image satisfies a first set of criteria, automatically generating a modified image including a stylized version of the object; and in accordance with a determination that the input image does not satisfy the first set of criteria, saving the input image without generating the modified image.

Example computer systems are disclosed herein. An example computer system is configured to communicate with one or more image sensors. The computer system comprises: one or more processors; and memory storing one or more programs configured to be executed by the one or more processors, the one or more programs including instructions for: obtaining, using the one or more image sensors, an input image including an object; and in response to obtaining the input image including the object: in accordance with a determination that the input image satisfies a first set of criteria, automatically generating a modified image including a stylized version of the object; and in accordance with a determination that the input image does not satisfy the first set of criteria, saving the input image without generating the modified image.

An example computer system is configured to communicate with one or more image sensors. The computer system comprises: means for obtaining, using the one or more image sensors, an input image including an object; and means, in response to obtaining the input image including the object, for: in accordance with a determination that the input image satisfies a first set of criteria, automatically generating a modified image including a stylized version of the object; and in accordance with a determination that the input image does not satisfy the first set of criteria, saving the input image without generating the modified image.

Automatically generating a modified image including a stylized version of the object when an image criterion is met provides for more efficient user-device interaction while preserving the privacy of users. Specifically, by automatically generating the modified image or storing the input image when certain criteria are met or are not met, the computer system provides feedback to the user related to the input image and/or an object detected in the input image while also storing the version of the image that will be helpful to the user without requiring further user input. In this manner, the user-device interaction is made more efficient and accurate (e.g., by providing feedback to the user about the input image, by reducing the amount of user inputs required to generate and/or store a specific version of the image, and by preserving user privacy automatically), which in turn reduces power usage and improves battery life of the device by enabling the user to use the device more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user’s eyes and hand in space or the user’s body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3A is a block diagram of a controller of the computer system, according to some examples.

FIG. 3B is a block diagram of an image generation unit, according to some examples.

FIG. 4 illustrates an architecture for a foundation model, according to some examples.

FIGS. 5A-5I illustrate input and generated stylized images, according to some examples.

FIG. 6 is a flow diagram of a method for generating stylized images, according to some examples.

### DETAILED DESCRIPTION

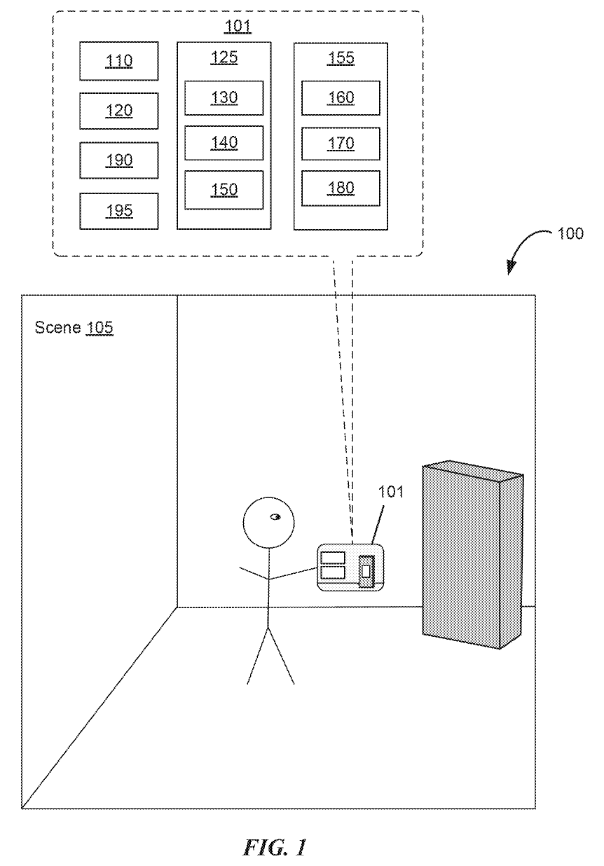

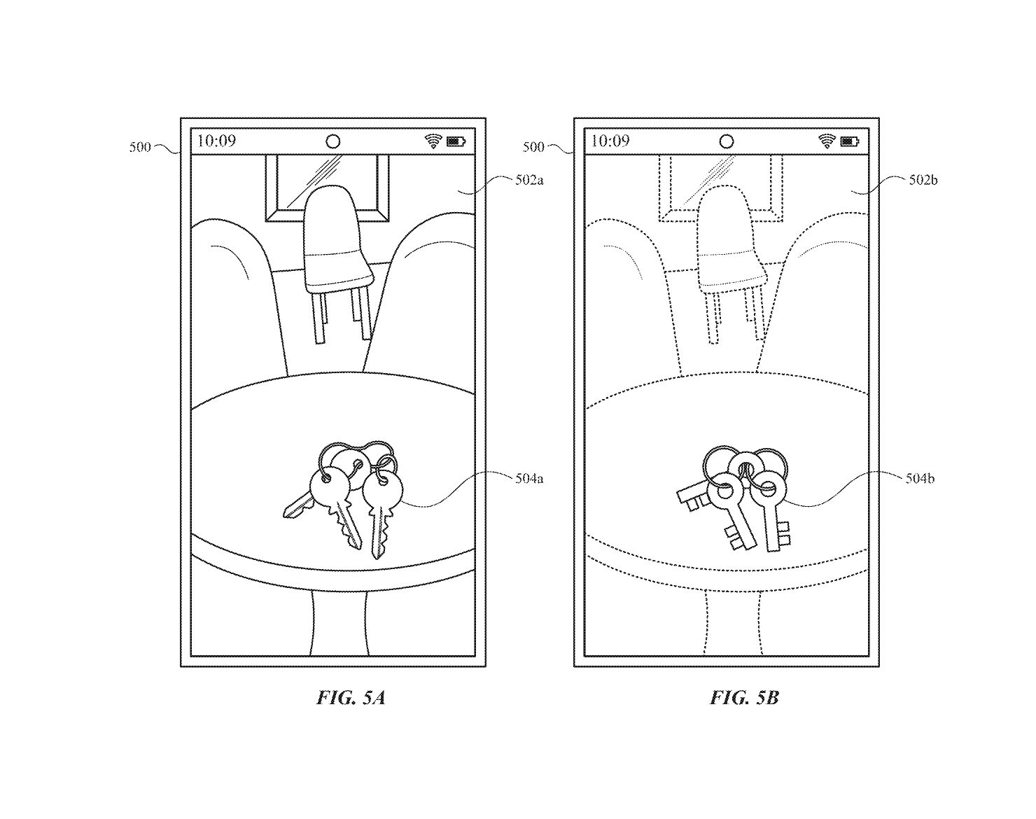

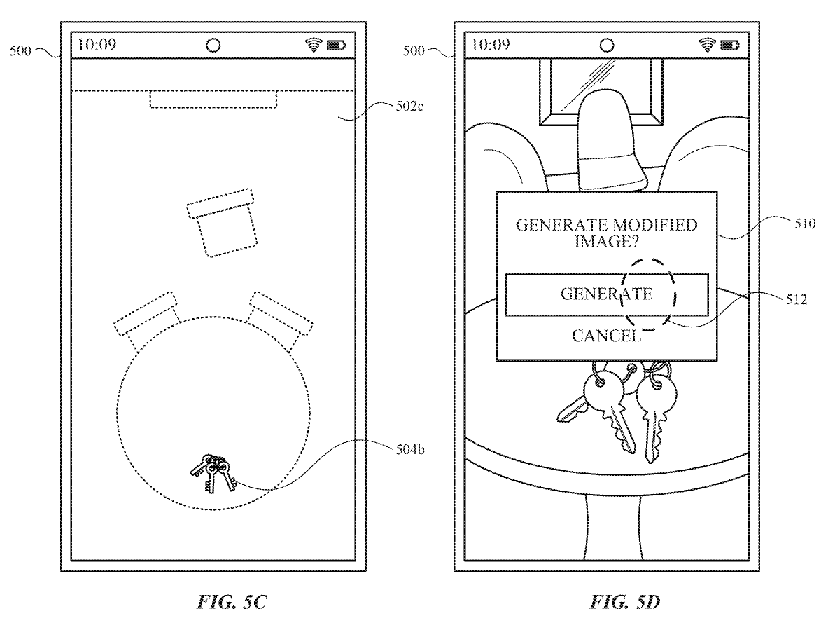

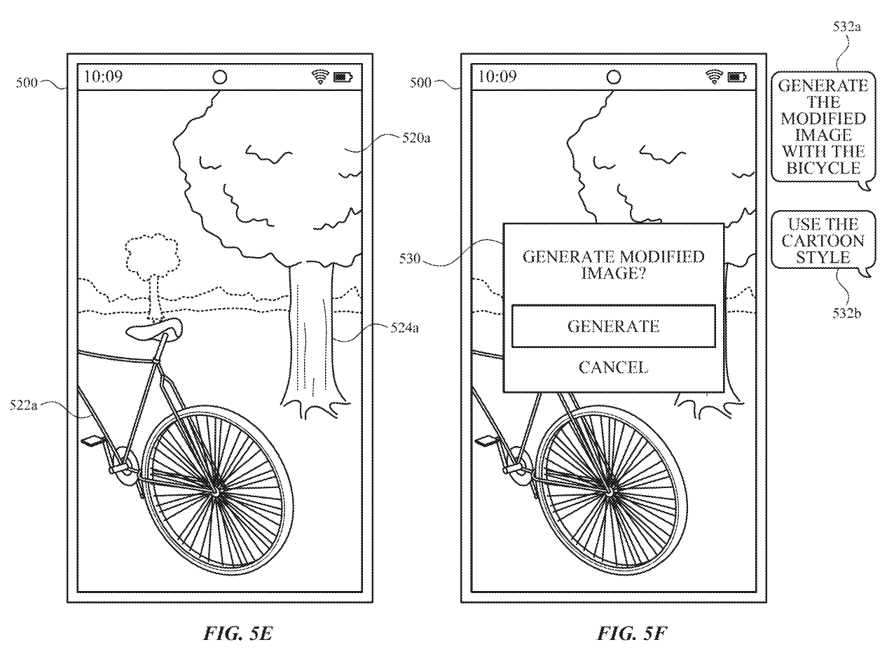

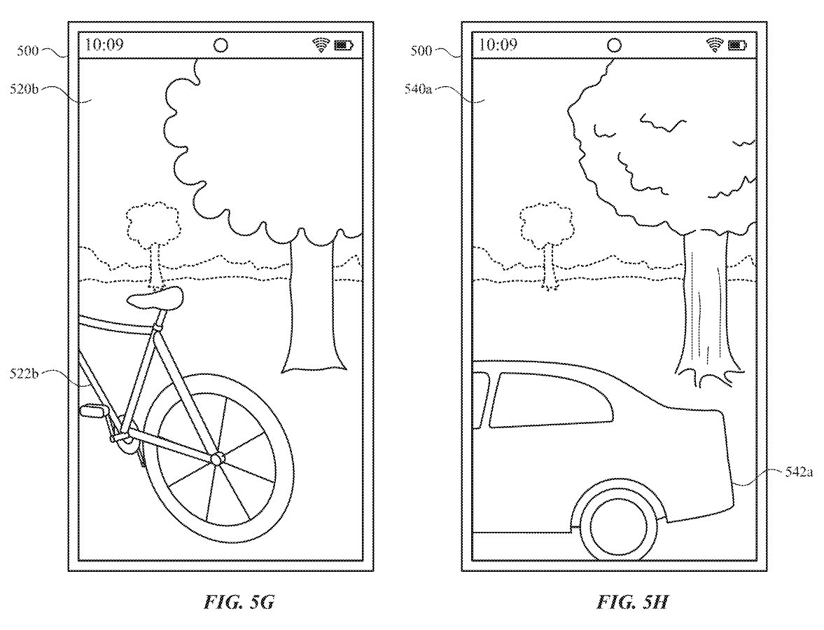

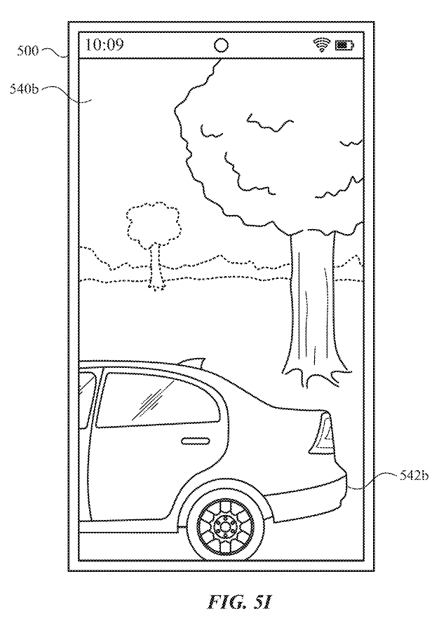

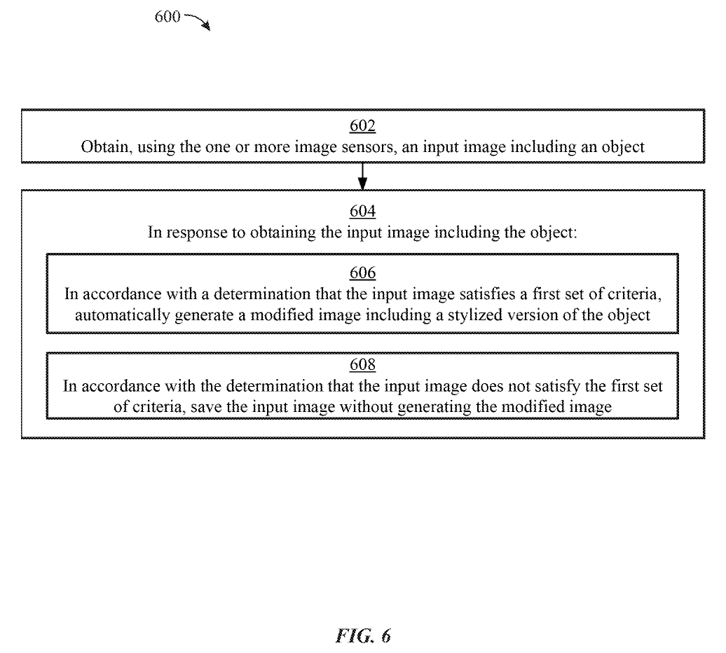

FIGS. 1-4 provide a description of example computer systems and techniques for interacting with three-dimensional scenes. FIGS. 5A-5I illustrate input and generated stylized images. FIG. 6 is a flow diagram of a method for generating stylized images. FIGS. 5A-5I are used to describe the method of FIG. 6.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

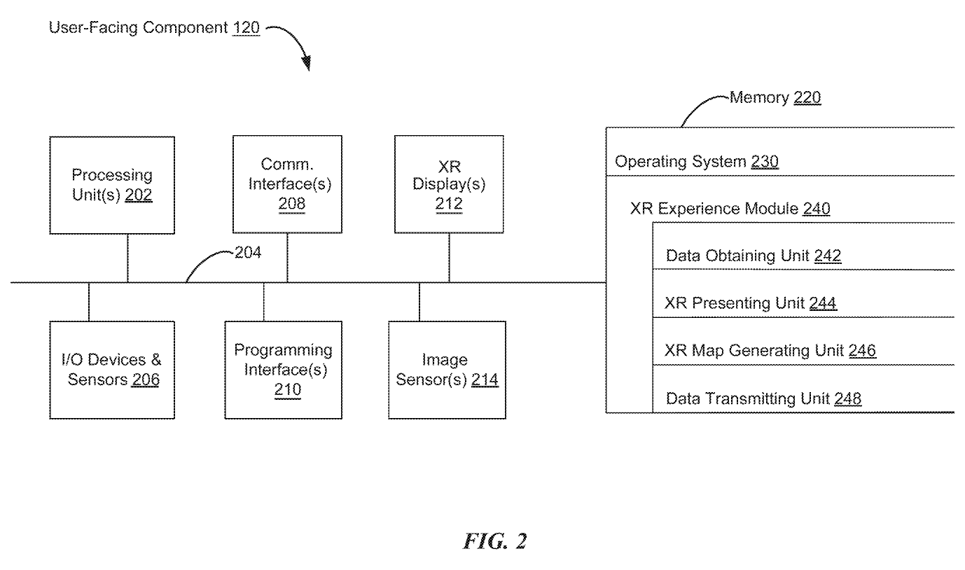

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user’s body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user’s body (e.g., the user’s eye(s), head, or hand)) could similarly be implemented with an HMD where the movement is caused by movement of the HMD relative to the physical environment (e.g., scene 105 or a part of the user’s body (e.g., the user’s eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user’s hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

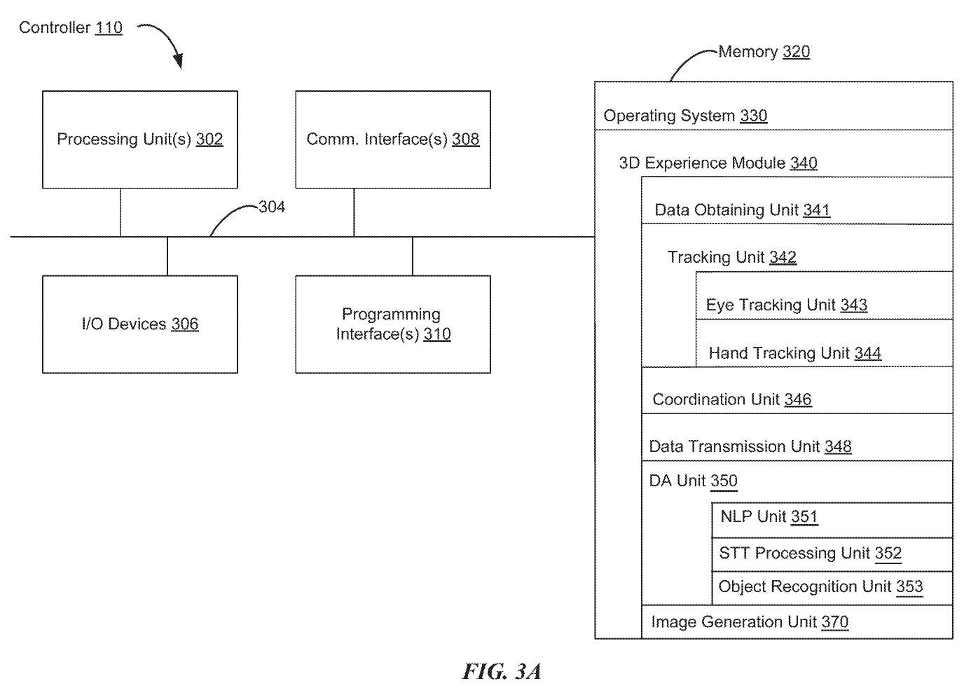

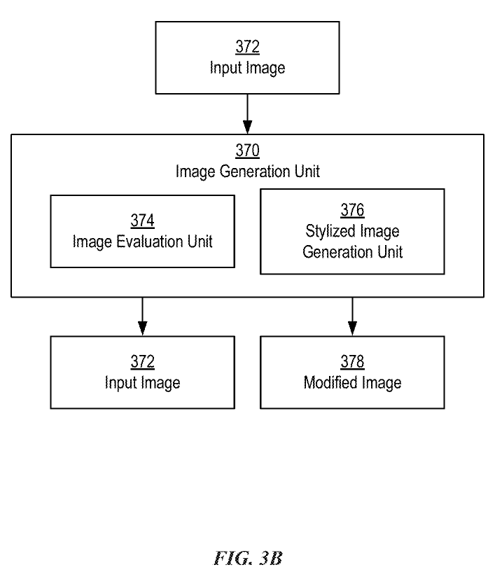

Returning to FIG. 1, controller 110 is configured to manage and coordinate a user’s experience with respect to a three-dimensional scene. In some examples, controller 110 includes a suitable combination of software, firmware, and/or hardware. Controller 110 is described in greater detail below with respect to FIGS. 3A and 3B.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3A-3B, 4, 5A-5I, and 6, are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3A is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3A is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3A could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and image generation unit 370.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user’s gaze (or more broadly, the user’s eyes, face, or head) using data obtained from eye tracking device 130. In some examples, eye tracking unit 343 tracks the position and movement of the user’s gaze relative to a physical environment, relative to the user (e.g., the user’s hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user’s eyes. The eye tracking cameras may be pointed towards the user’s eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user’s eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user’s hands and/or motions of one or more portions of the user’s hands. Hand tracking unit 344 tracks the position and/or motion relative to scene 105, relative to the user (e.g., the user’s head, face, or eyes), relative to a device worn or held by the user, relative to content displayed by user-facing component 120, and/or relative to a coordinate system defined relative to the user’s hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user’s hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user. In some examples, DA unit 350 performs at least some of: converting speech input into text (e.g., using speech-to-text (STT) processing unit 352); identifying a user’s intent expressed in a natural language input received from the user; actively eliciting and obtaining information needed to fully satisfy the user’s intent (e.g., by disambiguating terms in the natural language input and/or by obtaining information from data obtaining unit 341); determining a task flow for fulfilling the identified intent; and executing the task flow to fulfill the identified intent.

In some examples, DA unit 350 includes natural language processing (NLP) unit 351 configured to identify the user intent. NLP unit 351 takes the n-best candidate text representation(s) (word sequence(s) or token sequence(s)) generated by STT processing unit 352 and attempts to associate each of the candidate text representations with one or more user intents recognized by the DA. In some examples, a user intent represents a task that can be performed by the DA and has an associated task flow implemented in task flow processing unit 353. The associated task flow is a series of programmed actions and steps that the DA takes in order to perform the task. The scope of a DA’s capabilities is, in some examples, dependent on the number and variety of task flows that are implemented in task flow processing unit 353, or in other words, on the number and variety of user intents the DA recognizes.

In some examples, once NLP unit 351 identifies a user intent based on the user request, NLP unit 351 causes task flow processing unit 353 to perform the actions required to satisfy the user request. For example, task flow processing unit 353 executes the task flow corresponding to the identified user intent to perform a task to satisfy the user request. In some examples, performing the task includes causing computer system 101 to provide output (e.g., graphical, audio, and/or haptic output) indicating the performed task.

Image generation unit 370 includes instructions and/or logic for evaluating input images against particular criteria and automatically generating stylized images based on input images when criteria are met. In particular, as shown in FIG. 3B, image generation unit 370 includes image evaluation unit 374 and stylized image generation unit 376. Image generation unit 370 receives input image 372 and provides input image 372 to image evaluation unit 374 which determines whether input image 372 meets or does not meet one or more sets of image criteria.

In some examples, determining that input image 372 meets one or more sets of image criteria includes determining that the quality of input image 372 is below a threshold quality level, that input image 372 is taken at a location associated with privacy, and/or that input image 372 includes a predetermined type of object.

In some examples, the one or more sets of image criteria include one or more criterion that input image 372 is evaluated against. Exemplary image criteria include image quality criteria, image location criteria, privacy criteria, and object type criteria. Accordingly, in some examples, the one or more sets of image criteria includes individual criterion for quality, location, privacy, etc. In some examples, the one or more sets of image criteria includes a set of criteria for image quality, a set of criteria for image location, a set of criteria for user privacy, and/or a set of criteria for a type of object detected in input image 372. It will be understood that the one or more sets of criteria can include many different combinations of individual criterion and sets of criteria used to determine when modified image 378 should be automatically generated and/or when a prompt to generate modified image 378 should be provided.

In some examples, the one or more sets of image criteria include an image quality criterion. In some examples, the one or more sets of image criteria include an image location criterion. In some examples, the one or more sets of image criteria include a privacy criterion. In some examples, the one or more sets of image criteria include an object type criterion. In some examples, the one or more sets of image criteria include a set of image criteria for a first property, such as image quality, and a set of image criteria for a second property, such as image location and/or object type. These sets of criteria can be combined to determine whether input image 372 satisfies many different possible combinations of the properties discussed above, including image quality criteria, image location criteria, privacy criteria, and object type criteria.

When image evaluation unit 374 determines that input image 372 does meet one or more sets of image criteria, stylized image generation unit 376 automatically (e.g., without prompting for and/or without detecting further and/or additional user input) generates modified image 378 and stores modified image 378 for future reference and/or use by the computer system and/or the user.

In some examples, generating modified image 378 includes generating an abstract version of input image 372. In some examples, generating modified image 378 includes generating a version of input image 372 in which some or all of the features of input image 372 appear blurry. In some examples, generating modified image 378 includes generating a version of input image 372 that emphasizes one or more objects of input image 372 and de-emphasizes the rest of input image 372.

In some examples, generating modified image 378 includes generating a stylized version of an object included in input image 372. For example, the stylized version of the object can include an abstract version of the object, a version of the object that is enhanced to differentiate from the rest of modified image 378, and/or a version of the object with a particular style such as an emoji and/or cartoon style. Thus, modified image 378 retains important information about the object, such as its place within input image 372 and/or a location of input image 372, while obscuring other details that may not be important, may not be clearly visible within input image 372, and/or may need to be kept private.

In some examples, modified image 378 is generated without displaying input image 372. For example, image generation unit 376 can automatically generate modified image 378 when the one or more sets of image criteria are met without providing a user of the computer system with any of the information received with input image 372, including displaying input image 372. In this way the details of input image 372 that are helpful or important to the user will be preserved in modified image 378 without providing information that may be sensitive or less helpful (e.g., because input image 372 is not displayed).

In some examples, generating modified image 378 includes removing (e.g., isolating) an object from input image 372 and applying a style to the removed object. In some examples, modified image 378 includes the object without the other features of input image 372. In some examples, generating modified image 378 includes creating an emoji or other representation of the object without the other portions of input image 372 such that modified image 378 can be inserted and/or used with other applications and/or tasks.

In some examples, generating modified image 378 includes preserving the location of an object within input image 372 in a three-dimensional space. For example, while the object within input image 372 is abstracted as discussed above and the background of input image 372 is obscured or made more difficult to view (e.g., to preserve privacy) the location of the object within the three-dimensional space represented by input image 372 can be important to the user. Thus, the location of the object is preserved in modified image 378 so that the user may reference this information in the future.

In some examples, generating modified image 378 includes generating modified image 378 with a same point of view as input image 372. In some examples, generating modified image 378 includes generating modified image 378 with a different point of view as input image 372. This allows image generation unit 370 to preserve the point of view of input image 372 when that point of view may be relevant, such as when one object is on top of another object, while changing the point of view when other information is more important, such as when the position of the object in three-dimensional space is more easily viewed from above.

In some examples, modified image 378 is generated in response to detecting an input that specifies an object within input image 372. For example, input image 372 may include multiple objects that are visible and/or could be relevant to the user. Accordingly, the user can specify which of the multiple objects should be preserved in modified image 378 and stylized image generation unit 376 will generate modified image 378 to include the specified object.

In some examples, modified image 378 is generated in response to detecting an input that specifies a style to apply to an object of input image 372. For example, after displaying input image 372, image generation unit 370 detects a user input including a style that the user wants applied to the object of input image 372. After detecting this input, image generation unit 376 will generate modified image 378 to include the object with the specified style.

In some examples, modified image 378 is generated by applying a style to an object of input image 372 based on the type of object that is detected. For example, when a first type of object such as a vehicle is detected a particular style can be applied while when another type of object such as a tree is detected a different style can be applied. In some examples, modified image 378 is generated by applying a style to each of the objects of input image 372 based on the type of the object. Thus, continuing the previous example, a vehicle within modified image 378 is generated with a first style while a tree in modified image 378 is generated with a second style. This can help a user quickly distinguish between objects of modified image 378 to locate a particular object.

In some examples, modified image 378 is generated by applying a style that was previously selected to the object of input image 372. Examples of styles that are previously selected include a default style, a style to apply to a particular type of object, an option to apply a most recently selected style, an option to apply a favorite style, and/or any other type of style that can be selected by a user either in a settings interface or in another interaction with the computer system.

In some examples, modified image 378 is generated by applying a particular style when a set of criteria different from the initial one or more sets of image criteria is satisfied. For example, when image evaluation unit 374 determines that a first set of image criteria is met and provides input image 372 to stylized image generation unit 376 to create modified image 378, stylized image generation unit 376 determines whether a second set of criteria or a third set of criteria is met. When stylized image generation unit 376 determines that the second set of criteria is met stylized image generation unit 376 generates modified image 378 with a particular style while when stylized image generation unit 376 determines that the third set of criteria is met stylized image generation unit 376 generates modified image 378 with a different style. In some examples, when stylized image generation unit 376 determines that neither the second set of criteria nor the third set of criteria are met, stylized image generation unit 376 generates modified image 378 with a default style or forgoes generation of modified image 378 completely.

In some examples, when modified image 378 is generated by image generation unit 370, image generation unit 370 does not store and/or save input image 372. Rather, because modified image 378 has been stored, image generation unit 370 determines that the relevant information from input image 372 has been preserved and thus input image 372 is no longer needed.

When image evaluation unit 374 determines that input image 372 does not meet one or more sets of image criteria, image generation unit 370 stores input image 372 for future reference and/or use by the computer system and/or the user.

In some examples, when image evaluation unit 374 determines that input image 372 does not meet one or more sets of image criteria, image generation unit 370 causes a prompt including an option to generate modified image 378 to be provided as an audio and/or visual output. Thus, image generation unit 370 can provide the option to the user to create modified image 378 when the user desires, even if modified image 378 does not meet a particular set of criteria that has been determined.

In some examples, when image generation unit 370 causes a prompt including an option to generate modified image 378 to be provided as an output, image generation unit 370 detects an input selecting the option to generate modified image 378 and in response to detecting the input selecting the option to generate modified image 378, generates modified image 378 and stores modified image 378 for future reference, as discussed above.

In some examples, image generation unit 370 causes a prompt including an option to generate modified image 378 to be provided as an audio and/or visual output when a first set of criteria or a first criterion is met. For example, when one type of criteria is met image generation unit 370 automatically generates modified image 378, while when another type of criteria is met image generation unit 370 provides the option to generate modified image 378. In some examples, image generation unit 370 causes a prompt including an option to generate modified image 378 to be provided as an audio and/or visual output when a first set of criteria and/or a first criterion is met and a second set of criteria and/or a second criterion is not met.

In some examples, image generation unit 370 performs tasks such as object identification within input images or generation of stylized versions of images and/or objects without utilizing artificial intelligence models. For example, image generation unit 370 implements filters to identify objects within images and generates stylized images by applying one or more predetermined filters to an image. In other examples, as described below, image generation unit 370 performs tasks and/or partially performs tasks utilizing one or more artificial intelligence models.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 and/or image generation unit 370 are implemented using the AI model(s). For example, DA unit 350 implements one or more AI models to perform speech recognition, intent determination (e.g., natural language processing and/or image processing), object recognition, and/or response generation and image generation unit 370 implements one or more AI models to identify objects within input images and/or generate stylized versions of images and/or objects.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLaMA, LLaMA-2, and LLaMA-3 from Meta Platforms, Inc.

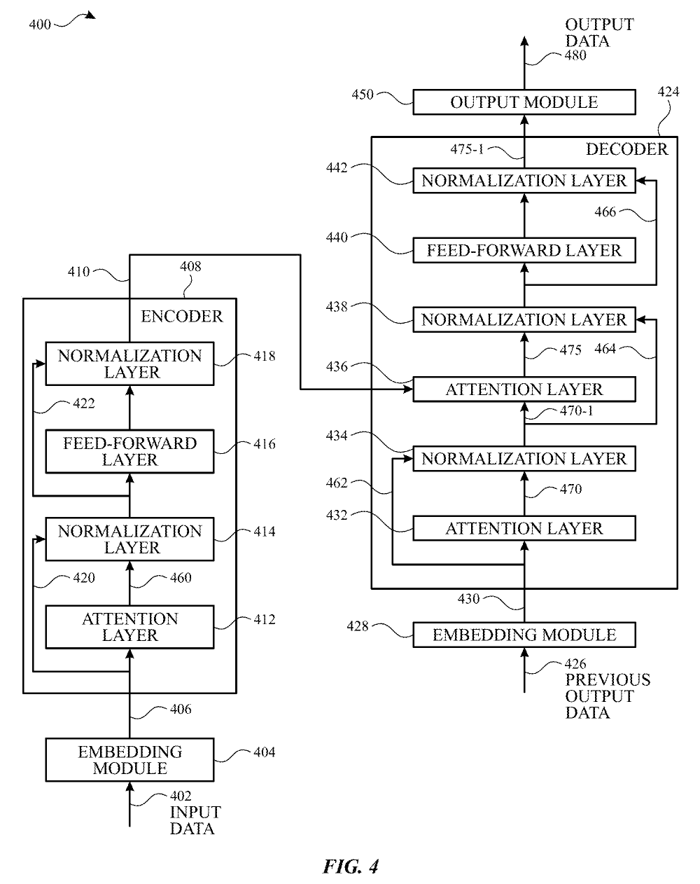

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding’s relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-5I illustrate input and generated stylized images, according to some examples.

Device 500 implements at least some of the components of computer system 101. For example, device 500 includes one or more sensors configured to detect data (e.g., image data and/or audio data) corresponding to the respective scenes. In some examples, device 500 is an HMD (e.g., an XR headset or smart glasses) and FIGS. 5A-5I illustrate the user’s view of the respective scenes via the HMD. For example, FIGS. 5A-5I illustrate physical scenes viewed via pass-through video, physical scenes viewed via direct optical see-through, or virtual scenes viewed via one or more displays of the HMD. In other examples, device 500 is another type of device, such as a smart watch, a smart phone, a tablet device, a laptop computer, a pair of display-less glasses, headphones, earbuds, or a projection-based device.

In FIG. 5A, input image 502a including keys 504a is obtained with device 500 using one or more sensors such as an image sensor of device 500 and displayed by device 500. In response to obtaining input image 502a, device 500 (e.g., using image generation unit 370) determines whether input image 502a satisfies a first set of criteria which can include exemplary criteria such as those discussed above including a location criterion and/or a quality criterion. When device 500 determines that input image 502a does not satisfy the first set of criteria because, for example, input image 502a was captured at a public location and/or input image 502a is of high enough quality to accurately convey information, device 500 does not generate a modified image and saves input image 502a.

When device 500 determines that input image 502a satisfies the first set of criteria because, for example, input image 502a was captured at a location associated with privacy (e.g., a person’s home) and/or input image 502a is low quality, device 500 generates (e.g., with image generation unit 370) modified image 502b as shown in FIG. 5B and/or modified image 502c as shown in FIG. 5C.

In FIG. 5B, device 500 displays modified image 502b including stylized keys 504b. Modified image 502b is generated by applying a style to keys 504a to create stylized keys 504b. For example, modified image 502b is generated by applying an emoji style to keys 504a so that stylized keys 504b of modified image 502b look similar to the emoji for keys. The other features of modified image 502b are obscured and/or made abstract to preserve the privacy of the location where input image 502a was captured and/or to reduce the number of low quality portions of the image. Modified image 502b is generated with the same point of view as input image 502a to preserve important information from input image 502a, such as the relationship between keys 504a and the table that keys 504a are placed on.

In some examples, device 500 generates modified image 502b and displays modified image 502b as shown in FIG. 5B without displaying input image 502a. Accordingly, device 500 does not display input image 502a as shown in FIG. 5A prior to displaying modified image 502b and instead shows modified image 502b.

In FIG. 5C, device 500 displays modified image 502c including stylized keys 504b. Modified image 502c is generated in substantially the same manner as modified image 502b discussed above, except that modified image 502c is generated with a different point of view from input image 502a. In particular, modified image 502c is generated with a top down point of view to better display the location of keys 504b within the room where input image 502a was taken.

In FIG. 5D, device 500 provides prompt 510 including the option to generate a modified image. Device 500 detects input 512 selecting the “generate” button of prompt 510 and in response to detecting input 512 generates modified image 504b and/or modified image 504c as shown in FIGS. 5B and 5C respectively. In some examples, device 500 provides prompt 510 in accordance with a determination that input image 502a does not meet (e.g., satisfy) the first set of criteria. In some examples, device 500 provides prompt 510 in accordance with a determination that input image 502a meets a first set of criteria but does not meet a second set of criteria.

In FIG. 5E, input image 520a including bicycle 522a and tree 524a is obtained with device 500 using one or more sensors such as an image sensor of device 500 and displayed by device 500. In response to obtaining input image 520a, device 500 (e.g., using image generation unit 370) determines whether input image 520a satisfies a first set of criteria which can include exemplary criteria such as those discussed above including a location criterion and/or a quality criterion. When device 500 determines that input image 520a does not satisfy the first set of criteria because, for example, input image 520a was captured at a public location and/or input image 520a is a high enough quality to accurately convey information, device 500 does not generate a modified image and saves input image 520a.

When device 500 determines that input image 520a satisfies the first set of criteria because, for example, input image 520a was captured at a location associated with privacy (e.g., a person’s home) and/or input image 520a is low quality, device 500 provides prompt 530 including the option to generate a modified image as shown in FIG. 5F. In particular, while device 500 determines that input image 520a satisfies the first set of criteria, device 500 cannot determine which object is important to the user and/or determines that input image 520a does not satisfy a second set of criteria. Accordingly, device 500 provides prompt 530 to confirm with the user that a modified image should be generated.

After providing prompt 530, device 500 detects user speech input 532a of “generate the modified image with the bicycle” and user speech input 532b of “use the cartoon style.” In response to detecting user speech inputs 532a and 532b, device 500 generates (e.g., using image generation unit 370) modified image 520b as shown in FIG. 5G. In particular, device 500 generates modified image 520b including stylized bicycle 522b with a cartoon style based on the information provided in user speech inputs 532a and 532b. Because user speech inputs 532a and 532b specify that the modified image is to include bicycle 522b in a cartoon style device 500 ensures that modified image 520b includes bicycle 522b shown in the specified style.

In some examples, device 500 applies a style to the object when generating image 520b because an object of a particular type is detected. For example, when device 500 detects that input image 520a includes bicycle 522a, device 500 generates modified image 520b including bicycle 522b with a cartoon style and automatically selects the cartoon style because a bicycle is detected within image 520a. Thus, device 500 determines to generate modified image 520b because the first set of criteria is satisfied and then generates modified image 520b with the cartoon style because a second set of criteria (that a bicycle is included within input image 520a) is met.

However, when device 500 detects that input image 540a, as shown in FIG. 5H, includes vehicle 542a, device 500 generates modified image 540b, as shown in FIG. 5I to include stylized vehicle 542b with a realistic style and automatically selects the realistic style because a vehicle is detected within input image 540a. Thus, device 500 determines to generate modified image 540b because the first set of criteria is satisfied and then generates modified image 540b with the realistic style because a third set of criteria (that a car is included within input image 540a) is met. Thus, in some examples, device 500 selects a style for an object within the input image based on a type of object that is detected within the input image.

In some examples, the style to apply to the detected object is previously selected by a user. For example, the style may be selected as a default style, a style to apply to a specific type of object, and/or a style that the user prefers. Thus, the user can select a style to be applied prior to device 500 obtaining the input image, allowing device 500 to automatically provide styles based on previous user selection.

Additional descriptions regarding FIGS. 5A-5I are provided below in reference to method 600 described below with respect to FIG. 6.

FIG. 6 is a flow diagram of a method 600 for generating stylized images, according to some examples. In some examples, method 600 is performed at a computer system (e.g., computer system 101 in FIG. 1 and/or device 500) that is in communication with one or more image sensors (e.g., a camera and/or a photo sensor. In some examples, the one or more image sensors are a part of the computer system (e.g., are at least partially inside of the computer system and/or are directly connected to the computer system). In some examples, the one or more image sensors are a part of another computer system. In some examples, at least one image sensor is a part of the computer system. In some examples, at least one image sensor is a part of another computer system. In some examples, at least one image sensor is a forward-facing camera of the computer system (e.g., the camera faces a front of the computer system). In some examples, at least one image sensor is a backward facing camera of the computer system (e.g., the camera faces the back of the computer system).). In some examples, method 600 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 600 are distributed across multiple computer systems, e.g., a computer system and a separate server system. Some operations in method 600 are, optionally, combined, the orders of some operations are, optionally, changed, and some operations are, optionally, omitted.

At block 602, an input image (e.g., 502a, 520a, and/or 540a) including an object (e.g., 504a, 522a, 524a, and/or 542a) is obtained (e.g., received, detected, and/or captured) using the one or more image sensors.

At block 606, in response to (604) obtaining the input image including the object and in accordance with a determination (e.g., by image generation unit 370) that the input image satisfies a first set of criteria, a modified image (e.g., 502b, 502c, 520b, and/or 540b) including a stylized version of the object (e.g., 504b, 522b, and/or 542b) is automatically generated (e.g., with image generation unit 370).

At block 608, in response to (604) obtaining the input image including the object and in accordance with a determination (e.g., by image generation unit 370) that the input image does not satisfy the first set of criteria, the input image is saved (e.g., by image generation unit 370) without generating the modified image.

In some examples, the input image is a low quality image and the determination that the input image satisfies the first set of criteria includes determining that the input image meets a quality criterion of the first set of criteria.

In some examples, the stylized version of the object includes a generated emoji of the object.

In some examples, the first set of criteria includes a private location criterion. In some examples, determining that the input images satisfies the first set of criteria further comprises determining that a location corresponding to the input image meets the private location criterion, and generating the modified image further comprises generating an abstract version of the input image. In some examples, generating the abstract version of the input image further comprises generating the abstract version of the input image including the stylized version of the object without displaying the input image.

In some examples, the modified image indicates the location of the object in three-dimensional space with the stylized version of the object. In some examples, generating the modified image further comprises generating the modified image with a point of view that matches a point of view of the input image. In some examples, generating the modified image further comprises generating the modified image with a point of view that is different from a point of view of the input image.

In some examples, method 600 further includes: in accordance with the determination that the input image does not satisfy the first set of criteria: providing a prompt including an option to generate the modified image; after providing the prompt including the option to generate the modified image, detecting an input selecting the option to generate the modified image; in response to detecting the input selecting the option to generate the modified image: generating the modified image including the stylized version of the object; and saving the modified image including the stylized version of the object.

In some examples, method 600 further includes: in response to detecting the input selecting the option to generate the modified image and after saving the modified image including the stylized version of the object, forgoing saving the input image.

In some examples, in accordance with a determination that a quality criterion of the first set of criteria is met, a prompt including an option to generate the modified image is provided. In some examples, after providing the prompt including the option to generate the modified image: an input that specifies a second object included in the input image is detected; and in response to detecting the input that specifies the second object included in the input image, the modified image including a stylized version of the second object is generated.

In some examples, after providing the prompt including the option to generate the modified image: an input that specifies a style to apply when generating the modified image is detected; and in response to detecting the input that specifies the style to apply when generating the modified image, the modified image including the stylized version of the object, wherein the stylized version of the object is created by applying the style is generated.

In some examples, method 600 further includes in accordance with a determination that the object included in the input image is an object of a first type, applying a first style when generating the modified image; and in accordance with a determination that the object included in the input image is an object of a second type different from the first type, applying a second style different from the first style when generating the modified image.

In some examples, method 600 further includes selecting a style to apply to the stylized object based on a previously received style selection.

In some examples, method 600 further includes in accordance with the determination that that the input image satisfies the first set of criteria: in accordance with a determination that the input image satisfies a second set of criteria different from the first set of criteria, applying a first style when generating the modified image; and in accordance with a determination that the input image satisfies a third set of criteria different from the first set of criteria and the second set of criteria, applying a second style different from the first style when generating the modified image.

In some examples, the first set of criteria includes a criterion based on a location where the input image is captured. In some examples, the first set of criteria includes a criterion based on a quality of the input image.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to output spoken responses to assist a user. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of outputting spoken responses for the user, the present technology can be configured to allow users to select to “opt in” or “opt out” of participation in the collection of personal information data during registration for services or anytime thereafter. In another example, users can select not to provide personal information data based on which on spoken responses are generated. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, spoken responses can be generated based on non-personal information data or a bare minimum amount of personal information, such as the content being requested by the device associated with a user, other non-personal information available to the service, or publicly available information.

What is claimed is:

1. A computer system configured to communicate with one or more image sensors, the one or more computer systems comprising:
one or more processors; and
one or more memories storing one or more programs configured to be executed by the one or more processors, the one or more programs including instructions for:
obtaining, using the one or more image sensors, an input image including an object;
in response to obtaining the input image including the object:
in accordance with a determination that the input image satisfies a first set of criteria, automatically generating a modified image including a stylized version of the object; and
in accordance with a determination that the input image does not satisfy the first set of criteria, saving the input image without generating the modified image.

2. The computer system of claim 1, wherein the determination that the input image satisfies the first set of criteria includes determining that a quality metric of the input image meets a quality criterion of the first set of criteria.

3. The computer system of claim 1, wherein the stylized version of the object includes a generated emoji of the object.

4. The computer system of claim 1, wherein the first set of criteria includes a private location criterion, wherein determining that the input images satisfies the first set of criteria comprises determining that a location corresponding to the input image meets the private location criterion, and wherein generating the modified image further comprises generating an abstract version of the input image.

5. The computer system of claim 1, wherein generating the abstract version of the input image comprises:
generating the abstract version of the input image including the stylized version of the object without displaying the input image.

6. The computer system of claim 1, wherein the modified image indicates the location of the object in three-dimensional space with the stylized version of the object.

7. The computer system of claim 1, wherein generating the modified image comprises:
generating the modified image with a point of view that matches a point of view of the input image.

8. The computer system of claim 1, wherein generating the modified image comprises:
generating the modified image with a point of view that is different from a point of view of the input image.

9. The computer system of claim 1, the one or more programs further including instructions for:
in accordance with the determination that the input image does not satisfy the first set of criteria:
providing a prompt including an option to generate the modified image;
after providing the prompt including the option to generate the modified image, detecting an input selecting the option to generate the modified image;
in response to detecting the input selecting the option to generate the modified image:
generating the modified image including the stylized version of the object; and
saving the modified image including the stylized version of the object.

10. The computer system of claim 9, the one or more programs further including instructions for:
in response to detecting the input selecting the option to generate the modified image and after saving the modified image including the stylized version of the object, forgoing saving the input image.

11. The computer system of claim 1, the one or more programs further including instructions for:
in accordance with a determination that a quality criterion of the first set of criteria is met, providing a prompt including an option to generate the modified image.

12. The computer system of claim 11, wherein the object is a first object, the one or more programs further including instructions for:
after providing the prompt including the option to generate the modified image:
detecting an input that specifies a second object included in the input image; and
in response to detecting the input that specifies the second object included in the input image, generating the modified image including a stylized version of the second object.

13. The computer system of claim 11, the one or more programs further including instructions for:
after providing the prompt including the option to generate the modified image:
detecting an input that specifies a style to apply when generating the modified image; and
in response to detecting the input that specifies the style to apply when generating the modified image, generating the modified image including the stylized version of the object, wherein the stylized version of the object is created by applying the style.

14. The computer system of claim 1, the one or more programs further including instructions for:
in accordance with a determination that the object included in the input image is an object of a first type, applying a first style when generating the modified image; and
in accordance with a determination that the object included in the input image is an object of a second type different from the first type, applying a second style different from the first style when generating the modified image.

15. The computer system of claim 1, the one or more programs further including instructions for:
selecting a style to apply to the stylized object based on a previously received style selection.

16. The computer system of claim 1, the one or more programs further including instructions for:
in accordance with the determination that that the input image satisfies the first set of criteria:
in accordance with a determination that the input image satisfies a second set of criteria different from the first set of criteria, applying a first style when generating the modified image; and
in accordance with a determination that the input image satisfies a third set of criteria different from the first set of criteria and the second set of criteria, applying a second style different from the first style when generating the modified image.

17. The computer system of claim 1, wherein the first set of criteria includes a criterion based on a location where the input image is captured.

18. The computer system of claim 1, wherein the first set of criteria includes a criterion based on a quality of the input image.

19. A non-transitory computer-readable storage medium storing one or more programs configured to be executed by one or more processors of a computer system that is in communication with one or more image sensors, the one or more programs including instructions for:
obtaining, using the one or more image sensors, an input image including an object;
in response to obtaining the input image including the object:
in accordance with a determination that the input image satisfies a first set of criteria, automatically generating a modified image including a stylized version of the object; and
in accordance with a determination that the input image does not satisfy the first set of criteria, saving the input image without generating the modified image.

20. A method, comprising:
at a computer system in communication with one or more image sensors:
obtaining, using the one or more image sensors, an input image including an object; and
in response to obtaining the input image including the object:
in accordance with a determination that the input image satisfies a first set of criteria, automatically generating a modified image including a stylized version of the object; and
in accordance with a determination that the input image does not satisfy the first set of criteria, saving the input image without generating the modified image.
